(19) United States
(12) Patent Application Publication
(10) Pub. No.: US 2012/0004822 A1
(43) Pub. Date: Jan. 5, 2012

(54) Method and Device For Controlling an Internal Combustion Engine

(76) Inventors: Matthias Siedentopf, Heimsheim (DE); Jochen Walther, Stuttgart (DE); Roger Busch, Esslingen (DE); Michael Schueller, Friolzheim (DE); Daniel Heitz, Sindelfingen (DE)

(21) Appl. No.: 12/087,956

(22) PCT Filed: Jan. 2, 2007
(86) PCT No.: PCT/EP2007/050004

§ 371 Date: Sep. 22, 2011

(30) Foreign Application Priority Data
Jan. 20, 2006 (DE) 10 2006 002 738.8

(51) Int. Cl. F02D 41/30

(52) U.S. Cl. 701/103

(57) ABSTRACT

A method and a device for controlling an internal combustion engine are described. At least one injector meters a certain fuel quantity to the internal combustion engine at a certain point in time on the basis of a first signal and/or a second signal. At least the first and/or the second signal is/are corrected using a correction value. The correction value is adapted on the basis of at least one information value which is provided by at least one compensation procedure.

### BACKGROUND INFORMATION

The present invention is directed to a method and a device for controlling an internal combustion engine as recited in the preambles of the independent claims. The subject matter of the present invention is also a computer program product.

DE 102 15 610 describes a device and a method for correcting the injection behavior of injectors in which an injected quantity compensation is performed at a plurality of test points for enhancing the efficiency. For this purpose, the quantity difference is measured at a plurality of test points, stored on the injector, and input into the control unit at the time of the first startup. On the basis of these test points, a correction characteristics map, which is used when controlling the injectors, is calculated in the control unit. This so-called injector quantity compensation is necessary, since injectors have different quantity characteristics maps due to their mechanical manufacturing tolerances. Quantity characteristics map is to be understood as the relationship between the injected quantity, the rail pressure, and the control time of the injector. This results in each individual injector filling the combustion chamber with different quantities of fuel despite an electrically defined control. These tolerances may be compensated by the injector quantity compensation. The disadvantage here is that the injectors must be measured at the end of the assembly line and the data input into the control unit. If the relationship between injected quantity and control time changes during the operation of the internal combustion engine, these tolerances cannot be taken into account using this method.

Another method and another device for controlling a fuel metering system of an internal combustion engine is known from DE 199 45 618. In this method the control time of at least one electrically operated valve determines the fuel quantity to be injected. The minimum control time during which fuel is actually injected is ascertained in certain operating states, or the fuel quantity which is metered during the minimum control time is ascertained. This method is also known as zero quantity calibration. The purpose of such zero quantity calibration is to precisely meter small injected quantities, in particular in a pilot injection. This method is performed during regular operation, but has the disadvantage that only a certain operating point is handled. This means that this method provides a correction value only for very small injected quantities. These correction values for small injection quantities are not directly applicable to long control times and/or large injected quantities.

### DISCLOSURE OF THE INVENTION

### Summary of the Invention

The device according to the present invention and the method according to the present invention having the features of the independent claims have the advantage over the related art that the injection system exhibits a well-defined behavior over the entire service life and all operating ranges of the engine and of the combustion processes. This method has several advantages over today's individual methods which apply with limitations. Due to the applicability in the entire range of the engine's characteristics map, no transition states occur regarding the adaptation, i.e., there are no transient states or the like. The behavior of the injection system, in particular of the injector, remains constant over the entire service life of the product. This results in advantages in the controller design, such as, for example, in the idling controller, since the system gain remains constant, or in the communication to other control units which in turn query the engine load, for example. The interactions in the injection system do not change over the service life, since both quantity and injection timing are corrected. The change in engine operating mode has no effect on the application of the method. This means that the method may be used in either homogeneous or partially homogeneous operation. The method works individually for each cylinder and may be combined with known methods for overall quantity regulation. It is advantageous in particular that no additional sensors or actuators are needed compared to today's systems.

These advantages are achieved essentially in that at least one first signal, which determines the duration or the end of the injection and/or a second signal which determines the start of the injection is/are corrected using a correction value. This correction value is adapted on the basis of at least one information value which is provided by at least one compensation procedure.

In a simple specific embodiment, this means that the correction values are stored in a characteristics map and the characteristics map values are adapted on the basis of at least one information value. The information values are provided in particular by a zero quantity correction, by a quantity compensation regulation, or another compensation method. It may be provided that both the duration and the start of the fuel injection are corrected. In simplified specific embodiments only the duration or only the start is corrected. It is advantageous in particular if the duration is corrected. A specific embodiment is advantageous in particular, in which the first signal and/or the second signal which determine the duration or the start of the fuel injection are stored in a characteristics map and these characteristics map values are directly adapted.

The adaptation may be configured in such a way that the output signals of the particular characteristics map are corrected additively or multiplicatively, i.e., the characteristics map values are directly modified.

The information values used normally represent one or more correction values for one operating point each. Thus, the information value which is predefined by the zero quantity calibration, for example, represents the correction value for small injected quantities. Other information values, on the contrary, may characterize the correction values for the same and/or other operating points. The information value preferably specifies the difference between the actually injected fuel quantity and the desired fuel quantity. If such fuel quantity signals are not available, other signals representing the variables characterizing the fuel quantities may also be used.

It may also be provided that signals characterizing the difference between the actually injected fuel quantity and the desired fuel quantity are analyzed. A corresponding signal may be ascertained on the basis of the rail pressure variation. A variable corresponding to the actually injected fuel quantity is preferably ascertained on the basis of the rail pressure variation over time or via the angular position of the crankshaft or of the camshaft during an injection, in particular a partial injection. It is advantageous in particular that this information value is ascertainable at almost all operating points. This simplifies the analysis considerably, since only an interpolation between stored values and no calculation of values via a correlation is required.

A conclusion is now drawn according to the present invention about the correction values of the other operating points of the correction characteristics map or pump characteristics map on the basis of these one or more correction values provided by an information value. It may be provided that a conclusion is drawn for all operating points or only for part of the operating points on the basis of the information value. It may be provided that the correction values of the zero quantity calibration are taken into account only up to a certain quantity value. This means that the information values are used at least for certain characteristics map ranges.

It is advantageous in particular that after adaptation the compensation procedures affect the first and/or second signal(s) only via the correction characteristics map. This means, for example, that if a quantity compensation regulation is used as the compensation procedure, these values are used for adapting the correction characteristics map. If this adaptation is completed, the compensation procedure no longer affects the control duration or the control start. This is possible because the corresponding errors and tolerances have already been taken into account by the correction according to the present invention. It is furthermore advantageous that in certain operating states the adaptation is suppressed, i.e., for example, the adaptation is suppressed for diagnosis. This is necessary because the adaptation also compensates deviations and tolerances based on errors. Error detection would therefore be made difficult. On the other hand, the adaptation values may be analyzed for error detection. It may thus be provided, for example, that errors are recognized when the absolute values of the adaptation values assume a certain value.

Correction according to the present invention takes place in such a way that a fixed known relationship exists between the first signal and the fuel quantity and between the second signal and the point in time when injection starts. This means that correction takes place in such a way that for the same control signal AD or AE the injector always. meters the same fuel quantity at the same point in time. The same control signals may always be used regardless of tolerances and aging phenomena.

The measures cited in the dependent claims make further advantageous improvements on and refinements of the device and method described in the independent claims possible.

### BRIEF DESCRIPTION OF THE DRAWINGS

Exemplary embodiments of the present invention are illustrated in the drawing and explained in greater detail in the description that follows.

FIG. 1 shows a block diagram of a device for injecting fuel into an internal combustion engine, and

FIG. 2 shows a block diagram of the procedure according to the present invention.

### DESCRIPTION OF THE EXEMPLARY EMBODIMENTS

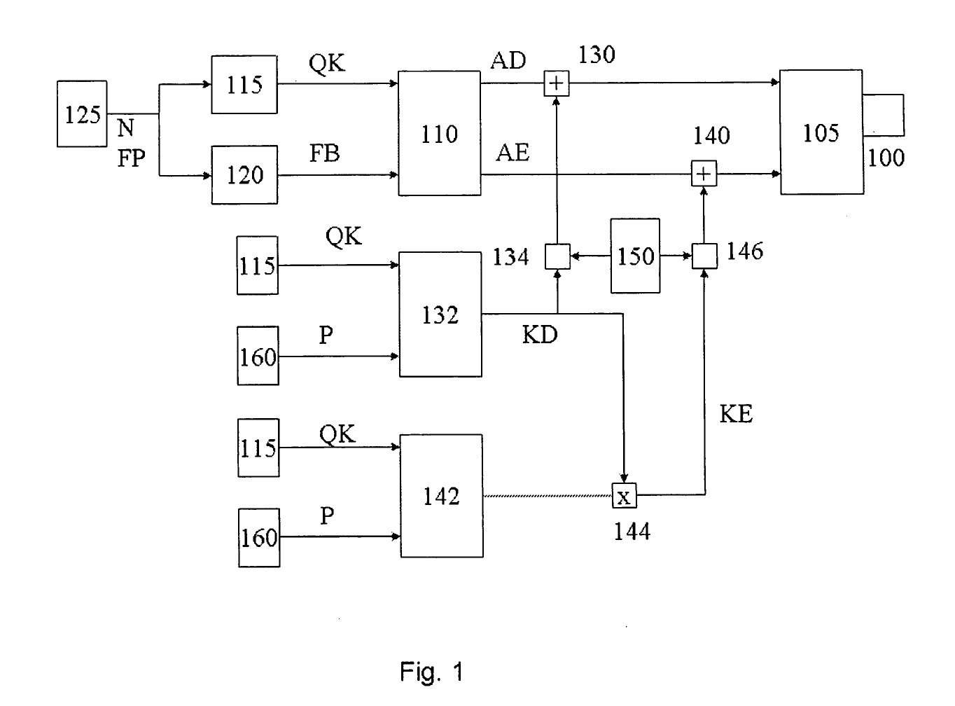

FIG. 1 shows a method and a device for controlling the injection of fuel into an internal combustion engine as a block diagram. Reference numeral 100 denotes an injector which controls the fuel supply into a combustion chamber of an internal combustion engine which is not depicted. An injector is normally provided for each cylinder of the internal combustion engine. An output stage 105 applies certain voltage values and/or certain current values to injector 100, enabling fuel metering at a certain point in time and terminating fuel metering at a second point in time. Output stage 105 in turn receives a first signal AD and a second signal AE.

First signal AE determines the start of fuel metering, and signal AD determines the duration and thus the end of fuel metering. The first and second signals are provided by a characteristics map 110, which is referred to hereinafter as control characteristics map 110, where control duration AD is stored essentially as a function of the injected fuel quantity QK and other performance characteristics such as, for example, fuel pressure p. Similarly, second signal AE is stored in a control characteristics map 110 as a function of the desired pumping start FB and other performance characteristics. These input variables regarding injected fuel quantity QK and pumping start FB are provided by a quantity selector 115 and a pumping start selector 120, respectively.

Quantity selector 115 and pumping start selector 120 calculate fuel quantity QK to be injected and pumping start FB, respectively, on the basis of output signals N, FP from different sensors 125. These signals preferably characterize the operating state of the internal combustion engine and/or the driver's input. In particular driver's input FB essentially determines fuel quantity QK to be injected.

It is now provided according to the present invention that output signal AD of control characteristics map 110 reaches output stage 105 via a node 130. Similarly, second signal AE reaches output stage 105 via a node 140. A first correction value KD, which is provided by a first corrector 132, reaches the second input of first node 130 via a switching means 134.

A second correction value KE reaches second node 140 from second corrector 142 via a node 144 and a second switching means 146. The two switching means 134 and 146 are controlled by a controller 150. Signal KD is applied to second node 144.

Both first corrector 132 and second corrector 142 receive different signals, which characterize different performance characteristics. These are in particular fuel quantity QK to be injected, which is preferably provided by quantity selector 115, and output signal P of a pressure sensor 160, which provides a signal which characterizes the pressure of the fuel being injected. Instead of the output signal of a pressure sensor, another variable which characterizes the fuel pressure may also be used. In particular a pressure variable which is calculated on the basis of other performance characteristics may be used. If the procedure according to the present invention is used in a so-called common rail system, pressure variable P is preferably the so-called rail pressure.

On the basis of different performance characteristics such as the fuel quantity to be injected, the pumping start and other performance characteristics such as fuel pressure P, the control characteristics map calculates the first signal which characterizes the control duration and second signal AE which characterizes the control start. A correction value is superimposed on these signals at nodes 130 and 140. In the depicted exemplary embodiment, additive correction takes place, i.e., correction value KD or KE is simply added to the output value of the control characteristics map. The procedure according to the present invention is, however, not limited to such an additive correction; it may also be provided for a multiplicative or another type of correction such as, for example, an additive and a multiplicative correction, i.e., in this case correctors 132 and 142 define an additive and a multiplicative correction value, respectively.

In one embodiment of the procedure according to the present invention, it may also be provided that the values in control characteristics map 110 are directly modified using correction values KD and KE.

Both first corrector 132 and second corrector 142 ascertain a correction value KD and KE, respectively, which are used for correcting the first or the second signal. The first corrector and the second corrector determine a correction value each for each operating point of injector 100. In the exemplary embodiment described here, the operating point of the injector is defined by the fuel quantity to be injected and fuel pressure P. It may also be provided according to the present invention that other variables which define the operating point are used here. It may also be provided in particular that further variables are used for defining the operating point, i.e., that other variables such as the temperature, for example, are used in addition to the fuel quantity to be injected and the rail pressure. It may furthermore be provided that instead of the fuel quantity to be injected, substitute variables that characterize these variables are used.

Output signal KD of first corrector 132 is used for correcting output signal AD of the control characteristics map. Correction value KE is used for correcting second signal AE, which characterizes the start of injection and is calculated by node 144 on the basis of first correction value KD and the output signal of second corrector 142. The two values are preferably multiplied in node 144 to ascertain second correction value KE.

In a particularly advantageous embodiment, it is provided that the correction values reach the first and second nodes via a first switching means 134 and a second switching means 146, respectively. This takes place against the background of the adaptation of the first and second signals being shut off in certain operating states. This shutoff is accomplished by controller 150. In the event of a shutoff, instead of the first correction value or the second correction value, the value zero is transmitted for an additive correction and the value one for a multiplicative correction. It may thus be provided that the above-described method is deactivated in certain operating states and/or during the occurrence of certain combustion processes such as in homogeneous and/or partially homogeneous operation, and is used only to a limited degree.

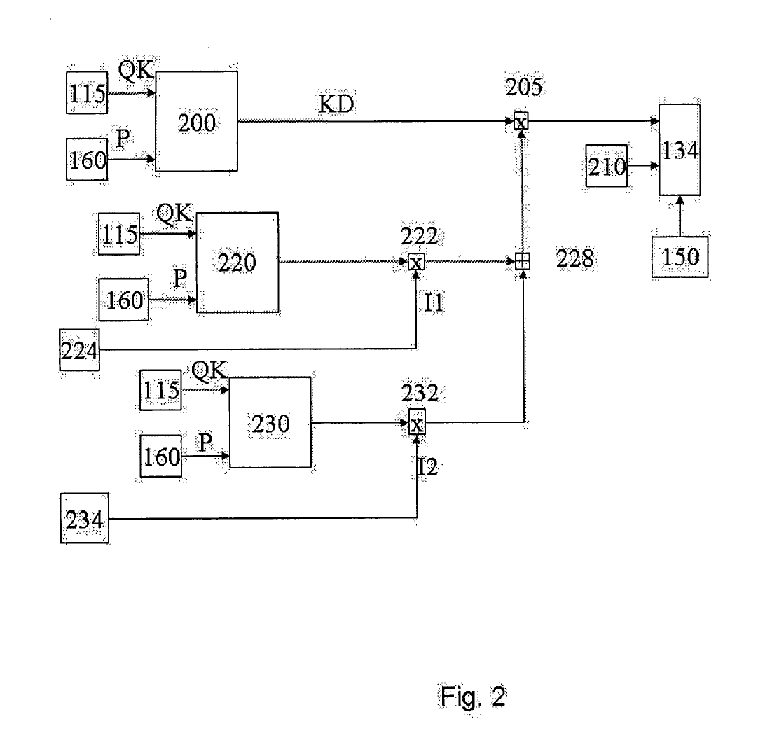

FIG. 2 shows first corrector 132 in greater detail. Elements previously described are identified in FIG. 2 with the same reference numerals. In the following, first corrector 132 is described in greater detail in FIG. 2. It is provided according to the present invention that second corrector 142 has an identical or at least similar construction. A correction characteristics map is labeled 200. Fuel quantity signal QK is applied to one of its two inputs and pressure signal P is applied to its other input. The correction values are stored in this characteristics map as a function of the operating point, which is defined by these two variables. These two variables are selected only as examples. Other characteristic variables may also be used for other injector types or other internal combustion engine types. It may furthermore be provided that, in addition to these variables, other input variables are used for defining the operating point. In particular, temperature values may also be used here. A correction value KD0 is stored in correction characteristics map 200 for each operating point as a function of these input variables. The correction value reaches switching means 134 via a node 205. The output signal of a zero value selector 210 is applied to the second input of switching means 134. Controller 150 selects either the output signal of zero value selector 210 or the output signal of node 205 for relaying to node 130.

In a first correlation characteristics map 220, correlation values are stored, also as a function of the operating point of the injector. These values are gated at a node 222 with a first information value I1. First information value I1 is provided by a first compensation function 224. Gating at node 222 takes place multiplicatively, for example. It may, however, also take place additively or additively and multiplicatively. The output signal of node 222 reaches node 205 via a node 228. In node 228, an additive gating is preferably performed, but a multiplicative or an additive and multiplicative gating may also be provided. In node 205 the two signals are gated, preferably multiplicatively.

A second correlation characteristics map is labeled 230, where correlation values are stored; at node 232 these are gated with an information value I2 provided by a second compensation method 234 as a function of different input variables which define the operating point of the injector. The output signal of node 232, which preferably performs a multiplicative gating, reaches node 205 via node 228. In a simplified embodiment, it may also be provided that the second correlation characteristics map and the corresponding nodes are omitted. In an improved embodiment, it may be provided that further correlation characteristics maps and further information values are provided by further compensation methods.

Basic values for correcting control duration AD are stored in correction characteristics map 200. These correction values, which are stored as a function of the operating state and for which a correction value is stored in the correction value characteristics map for each operating state, represent basic values which are then adapted on the basis of the contents of correlation characteristics maps 220 and/or 230, as well as on the basis of first and/or second information value I1, I2. The adaptation may take place in such a way that, on the basis of the values stored in the correlation characteristics map and of the information value, adaptation values are determined using which the output signal of correction characteristics map 200 is modified multiplicatively or additively or multiplicatively and additively. Alternatively it may be provided that, on the basis of the content of the correlation characteristics map and of the information value, the content of the correction characteristics map is modified accordingly.

The basic values stored in correction characteristics map 200 are preferably ascertained once and stored in the characteristics map. They are modified by adaptation in that in one specific embodiment the output signal of the characteristics map is corrected multiplicatively, additively, or multiplicatively and additively for each operating point or modified accordingly in that the characteristics map values are changed accordingly. The values stored for the first time are ascertained and input within the calibration of the vehicle. Alternatively it may also be provided that these values are input at the time of the first startup. Alternatively it may also be provided that these values are calculated on the basis of some essential basic values.

Different methods and procedures provide information, i.e., information values I1 and/or I2. These methods generally provide, for at least one operating point of the injector, a compensation value, using which the control duration is to be corrected in such a way that for an appropriate control signal the injectors supply an appropriate fuel quantity. Normally these information values are valid only at one operating point. In correlation characteristics map 220 correlation values which specify the relationship between the one information value at one operating point and the correction values at the other operating points are now stored for all operating points. This means that, on the basis of the one information value and the correlation characteristics map stored in correlation characteristics map 220 for all operating points, the correction value may be calculated for all operating points at node 222. This correction value thus calculated is superimposed on the output signal of the correction characteristics map at node 205. The procedure is similar for second information value I2.

It may also be provided according to the present invention that the correlation characteristics map only covers certain characteristics map ranges. For example, it may be provided that the information value provided by the zero quantity calibration is used only for small fuel quantities. In addition to the so-called zero quantity calibration, the values of the injector quantity compensation as known, for example, from DE 102 15 610, may also be used as information values. This so-called injector quantity compensation provides a plurality of information values for a plurality of operating points.

It may, however, also be provided that the values of the injector quantity compensation are used for forming correction characteristics map 200 and only compensation procedures which are performed ongoing operation provide an information value I1 or I2.

Any variables that characterize the difference between the actually injected fuel quantity and the desired fuel quantity may be used as the information values. The results of different compensation procedures may be used. Such compensation procedures use, for example, the rotational speed as the input variable. However, the compensation procedures may also analyze signals which characterize, for example, the exhaust gas composition such as its oxygen level or the combustion process such as, for example, the combustion chamber pressure.

It is furthermore possible that, by analyzing suitable signals, a variable which characterizes the actually injected fuel quantity is determined. Thus, for example, the injected fuel quantity may be calculated from the variation of the fuel pressure. The rail pressure of a common rail system may be analyzed for this purpose, for example. Alternatively an appropriate pressure signal may also be ascertained with the help of sensors which are situated in the supply lines between the rail and the injector or directly in the injector. This means that the injection end or the injection end and the injection start is/are detected on the basis of the variation of the rail pressure. The actually injected fuel quantity is ascertained on this basis. Alternatively, it may also be provided that the actually injected fuel quantity is ascertained on the basis of the pressure variation over time or over the crankshaft position.

The end of each individual partial injection of each injector is recognized via a pressure sensor mounted on the rail (alternatively on the injector supply line) on the basis of the characteristic variation of the pressure signal, and is compared with an expected injection end at the particular operating point. The injection end may now be mapped onto the expected value via controlled modification of the control timing due to the known behavior of the injector, which also provides a quantity equalization. The correction values are preferably stored as precontrol values for the following driving cycle.

This makes it possible to ascertain the desired partial injection quantity regardless of the operating point of the engine or its instantaneous combustion process. Adaptation (e.g., by storing the correction values in a suitable form) of the injector characteristics map is also possible. This means that the ascertained instantaneous injected quantity or a variable derived from the actual injected quantity is used as information value I. Since the injected quantity may be ascertained at all operating points, no correlation characteristics map is needed.

Ascertaining the injection end from the rail pressure signal represents only one possible variant. In one embodiment it may also be provided that the injection end is ascertained from other variables. Thus, for example, a suitable means, in particular a sensor that provides an appropriate signal, may be situated in the area of the injector. In particular it may be provided that a chip having an appropriate signal analysis is provided in the area of the injector.

The particular advantages of this specific embodiment are: The regulating circuit needs no special states of the engine or the vehicle and may thus be used in any situation. In particular it may also be used in a stationary engine. Due to the known injector behavior at any operating point, quantity changes due to the influence of previous injections are eliminated, and the interactions in the system and thus the complexity are thus reduced. No additional sensors are needed in systems having a rail because the existing sensors are used, or sensors which are then also available for other applications are utilized. No correlation behavior of the injector via quantity or pressure ranges is needed. This means that correlation characteristics maps 220 and 230 may possibly be omitted. The change in engine operating mode has no effect on the application of the method. The behavior of the injection system, in particular of the injectors, remains constant over the entire service life of the product. This results in advantages in the controller design, such as, for example, of the idling controller, since the system gain remains constant, for example, in the communication to other control units which in turn query the engine load, for example. The method works individually for each cylinder and may partially replace methods known today for overall quantity regulation or may be used in combination therewith. The individual correction values may be used for diagnostic purposes.

It is particularly advantageous if a threshold value query is performed. If the injection end recognized on the basis of the rail pressure differs from the expected value by more than a threshold value, an error is recognized. In particular a defective injector is thus recognized.

It may furthermore also be provided that in certain operating states in which the injected fuel quantity is known, for example, in idling operation and/or in full-load operation, the actually injected fuel quantity is detected with the aid of suitable sensors and by analyzing suitable signals and, on the basis of the detected fuel quantity, an information value is ascertained and used for correcting the correction characteristics map.

It is provided, for forming the correction value for the injection start, that correction value KD, which is also used for correcting the control duration, is weighted with the aid of corrector 142 via the operating point which is defined by the fuel quantity and the rail pressure, in order to ascertain the required correction value KE for correcting the control start. In such a simplified embodiment, second corrector 142 contains only an appropriate value characteristics map for each operating point.

1-10. (canceled)

11. A method for operating an internal combustion engine, in which fuel is supplied to at least one combustion chamber via at least one injector, the method comprising:
(a) dividing a total injection into a basic injection and at least one measured injection, setting n=1;
(b) reducing an injection time of the at least one measured injection and increasing an injection time of the basic injection so that a total injection quantity remains the same;
(c) determining a deviation, induced by (b), of a variable characterizing an actual mixture from a variable characterizing a setpoint mixture;
(d) determining an error injection quantity from the deviation of the variable characterizing the actual mixture from the variable characterizing the setpoint mixture for a particular measured injection time;
(e) forming a correction value as a sum of error injection times over time steps i=1 through n, and adjusting the characteristic of the injector by a sum of the error injection times during the particular injection time of the measured injection; and
(f) setting n=n+1 and returning to (b).

12. The method of claim 11, further comprising:
(d2) varying the basic injection quantity by the total of the error injection quantities, wherein (d2) is performed between (d) and (e).

13. The method of claim 12, wherein the sum of the error injection quantities is adjusted so that the variable characterizing the actual mixture deviates from the variable characterizing the setpoint mixture by less than a limiting value.

14. The method of claim 11, wherein the method is ended when the injection time of the measured injection at least reaches a lower limiting value.

15. The method of claim 11, wherein the total injection includes multiple measured injections of equal length.

16. The method of claim 11, wherein a delay time of the injector is taken into account when varying the injection time.

17. The method of claim 11, wherein the adjustment is evaluated and the result used to diagnose the injector.

18. A computer readable medium having a computer program, executable by a processor, comprising:
a program code arrangement having computer program code for operating an internal combustion engine, in which fuel is supplied to at least one combustion chamber via at least one injector, by performing the following:
(a) dividing a total injection into a basic injection and at least one measured injection, setting n=1;
(b) reducing an injection time of the at least one measured injection and increasing an injection time of the basic injection so that a total injection quantity remains the same;
(c) determining a deviation, induced by (b), of a variable characterizing an actual mixture from a variable characterizing a setpoint mixture;
(d) determining an error injection quantity from the deviation of the variable characterizing the actual mixture from the variable characterizing the setpoint mixture for a particular measured injection time;
(e) forming a correction value as a sum of error injection times over time steps i=1 through n, and adjusting the characteristic of the injector by a sum of the error injection times during the particular injection time of the measured injection; and
(f) setting n=n+1 and returning to (b).

19. An electronic readable medium having a computer program, executable by a processor, comprising:
a program code arrangement having computer program code for operating an internal combustion engine, in which fuel is supplied to at least one combustion chamber via at least one injector, by performing the following:
(a) dividing a total injection into a basic injection and at least one measured injection, setting n=1;
(b) reducing an injection time of the at least one measured injection and increasing an injection time of the basic injection so that a total injection quantity remains the same;
(c) determining a deviation, induced by (b), of a variable characterizing an actual mixture from a variable characterizing a setpoint mixture;
(d) determining an error injection quantity from the deviation of the variable characterizing the actual mixture from the variable characterizing the setpoint mixture for a particular measured injection time;
(e) forming a correction value as a sum of error injection times over time steps i=1 through n, and adjusting the characteristic of the injector by a sum of the error injection times during the particular injection time of the measured injection; and
(f) setting n=n+1 and returning to (b).

20. A control device for an internal combustion engine, comprising:
an electronic readable medium having a computer program, executable by a processor, including:
a program code arrangement having computer program code for operating an internal combustion engine, in which fuel is supplied to at least one combustion chamber via at least one injector, by performing the following:
(a) dividing a total injection into a basic injection and at least one measured injection, setting n=1;
(b) reducing an injection time of the at least one measured injection and increasing an injection time of the basic injection so that a total injection quantity remains the same;
(c) determining a deviation, induced by (b), of a variable characterizing an actual mixture from a variable characterizing a setpoint mixture;
(d) determining an error injection quantity from the deviation of the variable characterizing the actual mixture from the variable characterizing the setpoint mixture for a particular measured injection time;
(e) forming a correction value as a sum of error injection times over time steps i=1 through n, and adjusting the characteristic of the injector by a sum of the error injection times during the particular injection time of the measured injection; and
(f) setting n=n+1 and returning to (b).
